(19) United States
(12) Patent Application Publication
(10) Pub. No.: US 2009/0059837 A1
(43) Pub. Date: Mar. 5, 2009

(54) SYSTEM AND METHOD FOR MANAGEMENT AND ADMINISTRATION OF REPEATERS AND ANTENNA SYSTEMS

(76) Inventors: Morgan Kurk, Weare, NH (US); Milun Jovanovic, Buchdorf (DE); Arndt Pischke, Huisheim (DE)

Correspondence Address: WOOD, HERRON & EVANS, LLP (CommScope/Andrew), 2700 CAREW TOWER, 441 VINE STREET, CINCINNATI, OH, 45202, US

(21) Appl. No.: 12/200,135

(22) Filed: Aug. 28, 2008

Related U.S. Application Data
(60) Provisional application No. 60/969,461, filed on Aug. 31, 2007.

(51) Int. Cl. H04B 7/14

(52) U.S. Cl. 370/315

(57) ABSTRACT

A system for remote control of a remote network element of a wireless network is provided including an administration unit, a virtual private network implemented on a base network connecting the administration unit and the remote network element. An element manager application executes on the administration unit and is operable to remotely control the remote network element through the virtual private network.

### CROSS-REFERENCE TO RELATED APPLICATIONS

This application claims the benefit of U.S. Provisional Application Ser. No. 60/969,461 filed 31 Aug. 2007 and entitled SYSTEM AND METHOD FOR MANAGEMENT AND ADMINISTRATION OF REPEATERS AND ANTENNA SYSTEMS that is hereby incorporated in its entirety by reference herein.

### FIELD OF THE INVENTION

This invention relates generally to wireless network systems and devices and particularly to a system for remote management and administration of wireless devices.

### BACKGROUND OF THE INVENTION

Some implementations of private wireless networks may cover large areas and may require the use of one or more remote network elements (“RNE”), such as repeaters, transmission units, distributed antennas, or other transmission components. A repeater generally serves the purpose of strengthening a signal transmitted over a wireless network and wirelessly transmitting it again. The repeated signal is amplified and noise-filtered before being re-transmitted. The information contained in the transmitted signal remains unchanged by the actions of the repeaters. Repeaters are conventionally used to enlarge the range of a wireless network. In particular, coverage areas may be expanded and made accessible by positioning repeaters on a mountain summit, or in a tunnel, or building, or other shadowed area, for example.

Repeaters are commonly used in mobile wireless networks and other broadcast networks. Other transmission components are commonly used as interfaces between ground-based networks and wireless networks. These components are operable to convert received wireless signals into optical or electrical signals and feed these signals to ground based fiber or copper networks. Similarly, the transmission components can also convert ground based optical or electrical signals into wireless signals, which are sent out on the portable wireless network and through RNE's, such as repeaters.

RNEs are often set up at remote locations or in areas that may be difficult to access and are linked, often in a wireless fashion, to a larger mobile network, such as a public land mobile network (“PLMN”). Mobile networks often encompass a large number of repeaters and other transmission units, which are distributed over a comparatively spacious area. The remote and separated RNEs must be operated and managed like other devices linked to the PLMN. A centralized and remote-controlled administration of the RNEs is desirable for reduced complexity and for economic reasons. However, centralized administration is sometimes difficult to accomplish because many RNE's are positioned in remote locations or in locations that are difficult to access.

Centralized administration also presents challenges when the manager and the RNEs exist on different networks. Administration of the RNEs covers all activities that are targeted at the configuration or monitoring of the functions of the repeater or other transmission unit, as well as any troubleshooting. Further, administration covers the activities targeted at malfunctions, software bugs and updates, and system reboots.

Korean Patent Application No. KR 10 2005 0017216, which is herein incorporated by reference in its entirety, discloses a system and method for remotely controlling a repeater by establishing a wireless Internet network connection between a repeater and a remote control server using a TCP/IP transport application layer. Data is transmitted and received using a simple network management protocol (“SNMP”) message over the connection, thereby remotely controlling the repeater installed within a service coverage area. In this configuration, the manager and the repeater do not need to exist on the same local area network (“LAN”).

Some repeaters feature an internal web server, which provides an administration interface on the basis of the HTTP protocol. In such a case, a computer connected to the repeater via the Internet might be used as an administration station via a web browser installed on the computer.

Despite the above-noted techniques, the actual remote control of a repeater via a public Internet is, in practice, often further complicated or entirely prevented due to the fact that the repeaters used in many present-day mobile networks are not directly accessible via the public Internet. In fact, such repeaters are only accessible via the mobile network, to which they are linked. The mobile network is, in turn, often designed as a private network, with respect to various IP standards. Therefore, the communication between a repeater and the remote administration server, which is in most cases arranged outside of the private mobile networks, can only take place via a so-called gateway of the mobile network operator, which connects the mobile network with the public internet or with a further private IP-based network (LAN of the mobile network provider). Such gateways of most mobile network providers possess a firewall, for reasons of data security and manipulation. The firewall, in effect, protects the mobile network against the public Internet. In particular, SNMP- and HTTP-connections from the Internet to internal participants of the private mobile network, referred to as downlink communications (such as those to the repeater or RNE), are frequently blocked by the intermediary gateway. Such problems with remote control of repeaters also exist for other transmission units of a mobile network, as well as for various elements of other radio transmission networks, especially broadcast networks.

Such a difficult management scenario exists for the SNMP protocol noted above. The SNMP protocol uses a software manager and a software agent. However, as noted, there are problems with trying to control a repeater or other RNE in a private mobile network. The communications between an SNMP manager and an SNMP agent depend on the configuration of the transport media in between those elements. During the setup of an RNE network connection in a wireless network, an IP address is assigned to the RNE. Typical networks are configured to assign private IP addresses from a private range to the RNEs on the network. This presents several issues. An SNMP manager on a different network is not able to send IP packets to the SNMP agent (downlink direction, e.g., a SNMP “get” or “set” request) because of the private IP addresses of the RNE's. The IP packets from the SNMP manager can be transmitted through another network, such as the Internet, only if the RNE on the receiving network has a public IP address, which it usually does not have. The same problem exists when the RNE runs a web server for presenting web pages to a browser on another network, which may be used in some configurations for managing the RNE configuration. In these configurations, the HTTP client (browser) requests web pages by sending an HTTP “get” request to the web server, which would need a public IP address in order for the IP packets to be received.

SNMP is also used to transmit alarms (traps) from the RNE back to the management system (uplink direction). The RNE can send the alarm to the manager (which has a public address) even if the RNE has a private IP address. A gateway between the mobile network and the Internet transfers the IP packets from the private domain to the public domain (Internet) using network address translation (“NAT”). The public IP address of the gateway will be used as the sender's IP address. The gateway maintains a table that correlates the receiver's IP address with the sender's private IP address to route the response to the RNE. For security or commercial reasons, many gateways of mobile networks are configured to block certain protocols of the TCP/IP transport application layer. If the SNMP is one of the protocols that are blocked, the response back to the RNE will not be routed through the mobile network and the packets will be discarded.

This example illustrates that the method presented in the Korean application works only under limited circumstances, which are seldom used in practice. In Germany, for example, 3 out of 4 mobile network operators are using private IP addresses and the method described in the Korean application would not work per se.

Mobile network operators also have security concerns when the communication link between management system and RNE is not encrypted. One of the threats that the network operators see is a hacker eavesdropping on the unsecured SNMP communication over the Internet. The eavesdropping hacker can gain important information related to the access of the RNE. This information may be maliciously used, for example, to shut down RNEs on sites with high traffic, such as airports or sports arenas. This would result in many lost calls, upset customers, as well as a potential loss of revenue.

What is needed therefore is an alternate system to remotely administer RNE devices.

### SUMMARY OF THE INVENTION

Embodiments of the invention provide a system for remote control of a remote network element of a wireless network. The system includes an administration unit, a virtual private network implemented on a larger base network connecting the administration unit and the remote network element, and an element management application executing on the administration unit and operable to remotely control the remote network element through the virtual private network. In some embodiments, the system includes a VPN-Server operating the virtual private network. In a specific embodiment, VPN-Server is integrated in the administration unit.

In some embodiments, the base network includes a first network and a second network connected to the first network through a gateway. In an embodiment, the remote network element is connected to the second network and the second network is a private network. In a specific embodiment, the remote network element communicates on the second network via a TCP/IP application.

Embodiments of the virtual private network are protected by a cryptographic encryption, and may employ methods of virtual Ethernet tunneling in combination with the virtual private network. In a specific embodiment, the remote network element is a first remote network element and the system further includes a second remote network element connected to the administration unit through the virtual private network. A data exchange for the first and the second remote network elements for this embodiment may be encrypted separately. In some embodiments, the remote network element interfaces with the base network and is included in the virtual private network.

In some embodiments, the virtual private network is maintained between the administration unit and the remote network element. In other embodiments, the virtual private network connects the administration unit and the remote network element on-demand. In still other embodiments, the virtual private network may contain a combination of maintained and on-demand connections. In the embodiments that have on-demand connections, the virtual private network connection may be initiated with a message sent using SMS, may be initiated in response to an alarm at the remote network element, or may be initiated in response to a periodic heart beat signal.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the principles of the invention.

FIG. 1 is a schematic block diagram of a system for the remote administration of a transmission component of a wireless network consistent with embodiments of the invention.

FIG. 2 is a block diagram of a Virtual Private Network (VPN) as used in FIG. 1.

FIG. 3 is a schematic block diagram of an alternative system for the remote administration of a transmission component of a wireless network consistent with embodiments of the invention.

FIG. 4 is a schematic block diagram of another alternative system for the remote administration of a transmission component of a wireless network consistent with embodiments of the invention.

FIG. 5 is a schematic block diagram of a system for the remote administration of a transmission component of a radio/TV transmission network consistent with embodiments of the invention.

### DETAILED DESCRIPTION OF THE DRAWINGS

Embodiments of the invention provide a system for administering a remote network element, such as a repeater or antenna system, for example, securely through a public network such as the Internet. The term administer covers all activities which are targeted on configuration and or check-up of the proper function of the remote network element as well as any necessary troubleshooting. Further those activities which are targeted on the elimination of malfunctions, software bugs—for example reboot or debugging, or software updates are also embraced within the term administration. Virtual private networks (VPN's) are utilized to create secure communication paths between an administration unit of a network administrator or other operator and the remote network elements (RNE's), which may be connected to different networks, for communicating across a public network such as the Internet.

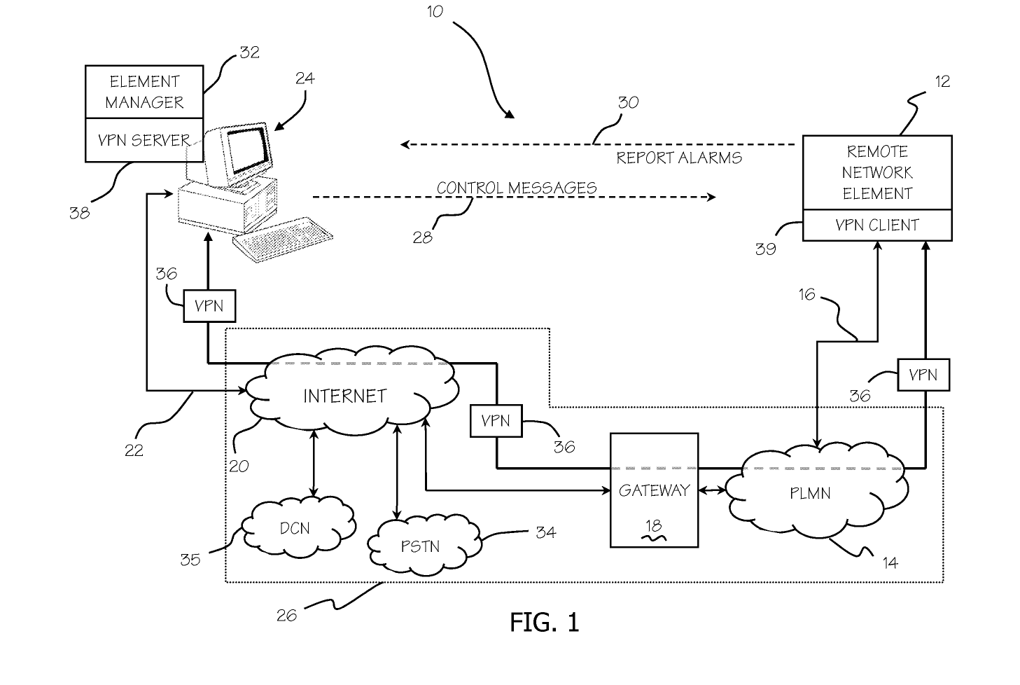

Referring now to FIG. 1, one exemplary embodiment of the invention is illustrated. An administration system 10 includes at least one remote network element (“RNE”) 12, such as a repeater, which is connected to a public land mobile network (“PLMN”) 14, such as a mobile telephone network or a private wireless network. Although a single RNE 12 is illustrated, multiple RNEs might be controlled in accordance with embodiments of the invention. The RNE 12 transmits and receives wireless signals through the PLMN 14 to communicate with user equipment, such as cellular phones and other wireless devices. Repeaters are often used, for example, to receive wireless signals, strengthen or amplify those signals, optionally remove any noise, and then rebroadcast them to extend the coverage of the network 14. The RNE 12 may be equipped in some embodiments with a wireless network card (not shown) or in other embodiments may contain both a wired and wireless connection to send and receive network data traffic over both connections.

For purposes of administration, the repeater might be accessible via a wireless link, such as link 16. Administration data, for which RNE 12 not only functions as a transmission unit, but also as a direct receiver or transmitter, can be transmitted via the PLMN 14. To that end, the RNE 12 might include a wireless modem, such as a GPRS modem (not shown). For security purposes, the PLMN 14 uses a gateway 18 to connect to a public network such as the Internet 20. An administration unit 24, such as an operating station from which an operator or administrator is able to monitor and execute administration activities, connects through a suitable network link or connection 22 to the Internet 20 in order to communicate with the RNE 12 on the PLMN 14.

Bi-directional communications can be set up over the Internet 20 and the PLMN 14, collectively referred to as a base network 26. Bi-directional communications allow the RNE 12 to be remotely administered by the administration unit 24 through the base network 26, gateway 18, and links 22, 16, assisting network administrators in being able to administer and troubleshoot their networks from a central location as discussed above. The base network 26 consists either of the public Internet 20 or of several connected partial networks of which at least one is a private network, such as PLMN 14. It depends on the integration of the RNE's, which is specifically given by the network provider. In the one embodiment of the invention, the RNE 12 is at least integrated in a partial network of the base network 26, whereas the partial network is the PLMN 14. Further networks, for example a public telephone network (not shown), may act as partial networks of the base network, with accordingly designed interfaces to at least one additional partial network.

Data flow from the administration unit 24 to the RNE 12 is referred to as the downlink direction 28, where the administration unit 24 is operable to send control messages and other administration instructions and data to the RNE 12 for the purpose of its operation remote from the site of the administration unit 24. The opposite data flow from the RNE 12 to the administration unit 24 is referred to as the uplink direction 30, allowing the RNE 12 to report alarms and other status messages and information to the administration unit 24 as appropriate. Administration is typically performed by the use of an element manager 32 (management application) executing on the administration unit 24. The element manager 32 may automatically directly control the RNE 12 in some embodiments, or the element manager 32 may utilize a configuration interface, such as a web interface, in other embodiments to allow an administrator or other user to change parameters and operating conditions of the RNE 12. The administration unit 24 may be a personal computer or workstation or a mobile computer, PDA, mobile phone, or the like. Several administration units 24 might also be utilized to realize the invention. The management application 32 can be implemented optionally entirely or partially in the administration unit 24 and/or in the RNE 12 or in a further hardware component of the base network. The management application 32 can also thereby be integrated entirely or partially in the operating system of the administration unit 24 or the RNE 12.

The base network 26 may represent a heterogeneous network, in some embodiments, which may include the PLMN 14, the Internet 20, a public telephone switched network (“PSTN”) 34, and/or a data communication network (“DCN”) 35. As described, these other networks could also be subject to the virtual private network and its features as described herein. Because the Internet 20 is a public network, it requires that systems, networks, and other communication termination points that are connected have public IP addresses as would be understood by a person of ordinary skill in the art. In some embodiments, the administration unit 24 is configured to communicate on the Internet 20 with a public address. The administration unit 24 may also communicate directly with the RNE 12 on the PLMN 14 or with other remote units on other sub-networks accessible to the administration unit 24.

However, many PLMN's 14 are private networks with private IP addresses, as discussed above. Therefore, trying to remotely manage and control the RNEs 12, such as by using an SNMP protocol, via the base network 26 shown in FIG. 1 presents various problems and difficulties noted above due to the private status of the PLMN 14 and the RNEs 12. The data traffic between the networks of the base network 26 is restricted by gateway 18 and any firewall (not shown). For example, an SNMP manager will not be able to send IP packets to the SNMP agent in the downlink direction 28, as the data is restricted. Also, even though the SNMP agent might be able to transmit alarms (for example, in the uplink direction 30 to the manager 32) due to security or other commercial reasons, the gateway 18 or firewall operating within gateway 18 is configured to block certain protocols, such as data traffic based on the SNMP or HTTP protocol. If the SNMP protocol is blocked, the response to the RNE 12 is not routed through the PLMN 14. The packets are instead discarded.

In a specific embodiment illustrated in FIG. 1, the PLMN 14 is a private wireless network having a series of private IP addresses assigned to the various components that are connected to the PLMN 14 by network links 16. As previously noted, a firewall configured and operating in the gateway 18 limits and screens the data traffic between the sub-networks of the base network 26, e.g., the Internet 20 and the PLMN 14. From the view of the gateway 18, data flowing in the uplink direction 30 is more trusted than data flowing in the downlink direction 28 as it has originated on the private network. Data streams and some network protocols and packets transmitted over the public Internet 20 may be blocked by the firewall in the gateway 18 due to low levels of trust, preventing the data flow from reaching the RNE 12 as discussed above. The present invention addresses these difficulties and solves the problems associated with remote control of the RNE's 12.

The invention includes a virtual private network, or VPN 36. A VPN provides private data exchange between a number of communication-participants inside of a larger base network. Such data, which is only available for the VPN participants, but not further participants of the base network, is called “private” data. In one embodiment of the invention, a virtual private network (“VPN”) 36 is utilized within the base network 26 and provides a secure connection between the RNE 12 and administration unit 24 through the base network 26, allowing for secure transmissions in both the downlink 28 and uplink 30 directions. In one embodiment of the invention, the VPN 36 is configured as an SSL VPN with an IP tunneling functionality, based on “virtual Ethernet tunneling.” As is generally known in the art, a virtual Ethernet tunnel uses packet encapsulation, Ethernet bridging, and IPSec encryption to “tunnel” a private subnetwork from one host to another over another public network (generally, the Internet). SSL or secure socket layer is a protocol that provides secure communications on the Internet for such things as web browsing, e-mail, Internet faxing, instant messaging and other data transfers as is also generally known in the art. Data transmission in the VPN occurs via a “tunnel” between a VPN-server 38 and a number of defined and identifiable VPN-clients 39 incorporated in RNE 12 in this embodiment. The data traffic inside of the tunnel is decoupled from the base network 26, and thus the communication inside of the VPN 36 is defined by special encoding managed by the VPN 36. The term “encoding”, as used throughout this application, is distinguished from cryptographic encoding. In other words, communication on the VPN 36 may use, but does not require cryptographically encoded transmissions. The VPN 36 exists rather on a syntactic level, which is superior to the normal data transfer over the base network 26 for the purpose of remote control of RNE's 12.

In one embodiment of the VPN 36, symmetric encryption is used. Symmetric encryption algorithms are a class of algorithms for cryptography that use trivially related, often identical, cryptographic keys for both decryption and encryption. The encryption key is trivially related to the decryption key, in that the keys may be identical or there may be a simple transform to go between the two keys. The keys, in practice, represent a shared secret between two or more parties that can be used to maintain a private information link and protect data confidentiality. Both sides of the tunnel share common encryption and decryption keys and use them to encrypt all traffic in both directions. In other embodiments, other cryptographic encoding methods may be used based on the IPSec or SSL/TLS standards as are well known to one of ordinary skill in the art.

Using the VPN 36 of the invention, a gateway, such as gateway 18, which may be arranged between the administration unit 24 and the RNE 12 and which may influence the communication between administration unit 24 and RNE 12, may be circumvented. The access of the administration unit 24 to the RNE 12 is basically independent from the integration of the RNE 12 in the base network 26, and the application of the VPN 36 provides transmission of administration-aimed data between the administration unit 24 and RNE 12. In other words, the VPN 36 allows a remote control of the RNE 12, independent of whether the transmission unit is directly integrated in the public Internet or in a private network. Furthermore, remote control of the RNE 12 is basically independent of safety-related adjustments of a gateway 18 connecting to the private PLMN network 14, with the public Internet 20.

Traffic through the VPN 36 may include any type of data transmission created by any type of communications protocol, such as the SNMP and HTTP protocols. Both SNMP and HTTP are transmitted over a TCP/IP transport application layer, which is a common communication layer used by many different systems on conventional networks. Other communications protocols using the TCP/IP transport application layer may include the dynamic host configuration protocol (DHCP), the domain name system (DNS), the file transfer protocol (FTP), the gopher news service, the Internet message access protocol (IMAP), the Internet relay chat (IRC), the network news transfer protocol (NNTP), the extensible messaging and presence protocol (XMPP), the coding standard multipurpose Internet mail extensions (MIME), the post office protocol (POP), the session initiation protocol (SIP), the simple mail transfer protocol (SMTP), the secure shell (SSH), the teletype network (TELNET), the border gateway protocol (BGP), the remote procedure call (RPC), real-time transport protocol (RTCP), the transport layer security or secure socket layer (TLS/SSL), the session description protocol (SDP), and or the simple object access protocol (SOAP). Other transport application layers, such as UDP, DCCP, SCTP, and RSVP may also be implemented with the VPN 36 of the invention.

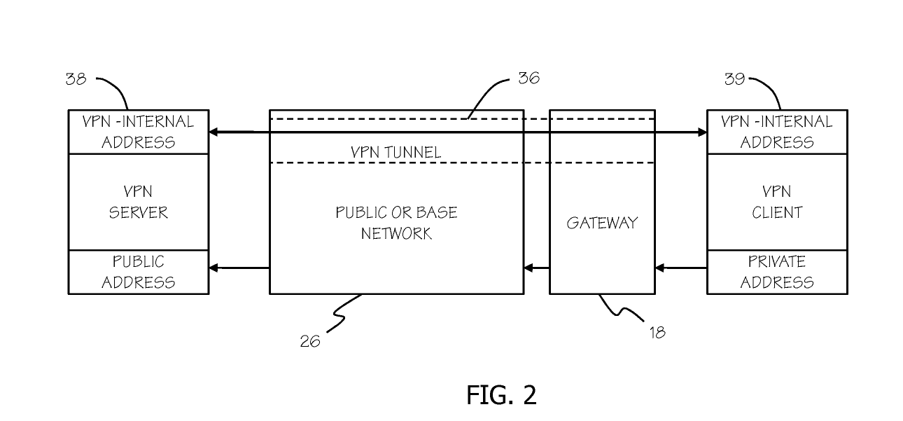

With reference to FIG. 1 and FIG. 2, and in one embodiment of the invention, a VPN server 38 is implemented in the administration unit 24. The VPN 36 establishes its own network with its own IP addresses as seen in FIG. 2. The central VPN server 38 administers those IP addresses. The various remote devices or RNEs 12 then act as clients 39 using the VPN IP addresses on VPN 36. For successful communication establishment, it is important that the VPN server 36 has a public IP address. The VPN client 39 on RNE 12 communicates through the base network 26 to the VPN server 38 and, after an authentication procedure, the VPN server 38 assigns an IP address from its own range in the VPN 36 to the VPN client 39 on RNE 12 as shown diagrammatically in FIG. 2. The VPN client 39 on RNE 12 is configured to announce itself at each restart automatically at the VPN server 38 to enable the RNE 12 to make contact with the element manager 32. This address exchange functionality uses the fact that the VPN server 38 is always publicly addressed.

After the VPN server 38 establishes a connection with the VPN client, such as the client 39 on RNE 12, the administration unit 24 is able to transmit and receive packets from the element manager 32 executing on the administration unit 24 and the RNE 12 through the VPN 36. The packets are able to pass through the gateway 18 in both directions through virtual Ethernet devices established with the VPN 36 connection. Transmissions through the VPN 36 are encrypted on the transmitting end and then decrypted on the receiving end to provide security for the transmission. As an added layer of security in one embodiment of the invention, the VPN 36 utilizes additional encoding and encryption layers known in the art by employing an SSL/TLS protocol, as is used with the OpenVPN implementation. OpenVPN uses an OpenSSL library to provide encryption of both the data and control channels. The OpenVPN implementation utilizes OpenSSL do all the encryption and authentication work, enabling OpenVPN to use all the ciphers available in the OpenSSL package. OpenVPN can also be configured to use the HMAC (“Hash Message Authentication Code”) packet authentication feature to add an additional layer of security to the connection.

An important component in a successful link between the VPN server 38 and the VPN client 39 according to the invention is the usage of a tunneling feature. The VPN 36 in one embodiment of the invention is based on virtual Ethernet tunneling. The tunneling functionality may be provided through a TUN/TAP virtual network driver, similar to the OpenVPN implementation, to tunnel a sub-network from one host to another over a public network such as the Internet 20. Using the tunnel, an entire IP packet (data plus the message headers) is encrypted and/or authenticated. The IP packet must then be encapsulated into a new IP packet in order for routing to work. The tunnels provide a means to bypass firewalls and other gateways that prohibit certain Internet services provided that outgoing connections are allowed on some TCP/IP ports. Additionally, lightweight cryptographic encryption, such as symmetric encryption may be utilized in the tunnel to provide security to the data as it is transmitted through public networks. Other encryption methods may additionally be used in other embodiments as set forth above and as are known in the art. This tunnel can be used by any application or protocol and is semi-permanent, meaning it will stay up indefinitely provided both end points continue to desire its existence.

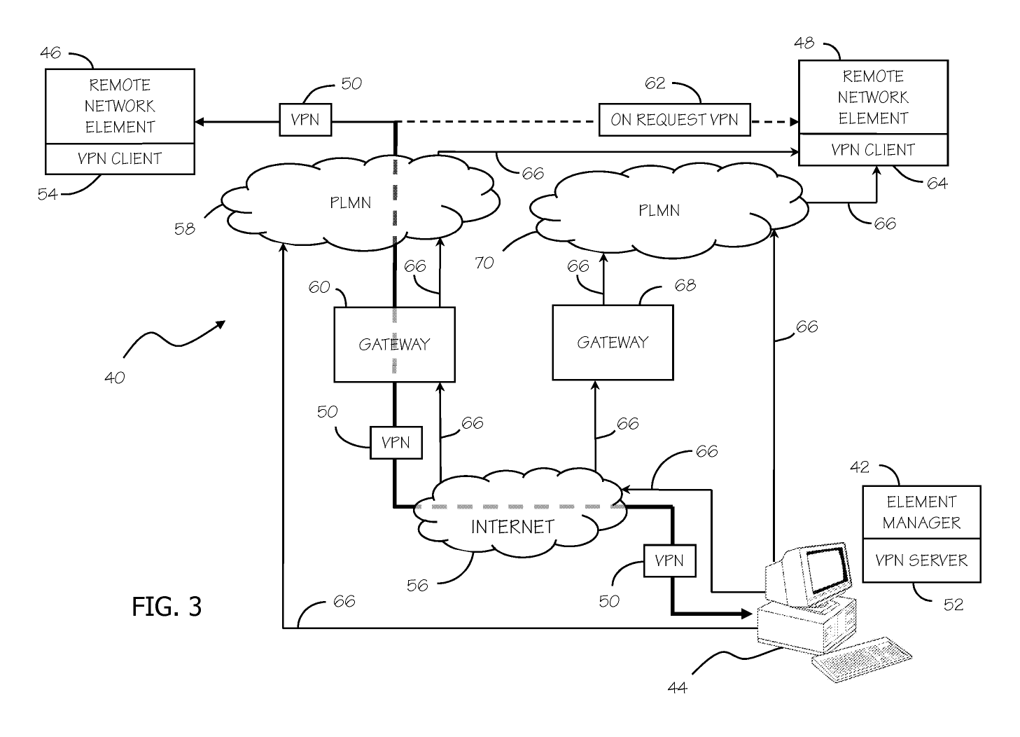

In some embodiments, such as the system 40 in FIG. 3, some or all of the VPN connections may be established only when needed. For example, and with reference to FIG. 3, the element manager 42 executing on an administration unit 44 may administer RNEs 46 and 48. For connections that are “permanent” in nature, the RNE 46 communicates through a permanent VPN 50 established by a VPN server 52, which has assigned a unique IP address within the VPN 50 to VPN client 54 on RNE 46, similar to the embodiment disclosed above. The VPN 50 similarly uses a public network, such as the Internet 56, and connects through a private PLMN 58, through a gateway 60, also similar to that disclosed above.

However, in this embodiment, RNE 48 does not utilize a “permanent” or “always on” connection through the VPN 50. RNE 48 in this particular embodiment utilizes an on request connection 62, only establishing the VPN connection when needed to transmit information back to the element manager 42, or when the element manager 42 needs to communicate with the RNE 48. The on request connection 62 may be triggered via a message using a short message service (SMS) or by an event such as an alarm or a periodic heartbeat.

SMS is a communication protocol allowing the interchange of short text messages between mobile telephone devices. These short text messages may be utilized as a wake-up event for the VPN client 64 on RNE 48. For example and as shown in FIG. 3, the element manager 42 initiates a communication with RNE 48. The VPN server 52 sends a standard SMS message 66 to the VPN client 64. The SMS message 66 may be transmitted through the Internet 56 to gateway 60 and then through PLMN network 58 or the SMS message 66 may alternately be transmitted through the Internet 56 to gateway 68 and through PLMN network 70 to reach RNE 48. In many cases, the SMS message 66 is transmitted from the VPN server 52 through a wireless modem (not shown) which is connected to the administration unit 44 directly to the PLMN, either 58 or 70, and then to RNE 48. PLMN network 58 may be a home GPRS network and PLMN network 70 may be a visited GPRS network as is known in the art. When the SMS message 66 is received, the VPN client 64 on RNE 48 communicates an authentication through the network segment 62 to establish a VPN connection with the VPN server. Once the VPN communication has been established, the VPN client 64 on RNE 48 will be assigned an IP address within the VPN 50 by the VPN server 52 and the RNE 48 is able to communicate with the element manager 42 through the VPN 50 and on request segment 62.

The wakeup SMS message 66 may generally contain an “attach” command followed by and identification number, such as the sender's phone number, for authentication and identification of the sender. The format of the “attach” command may be “attach”, “Attach”, or “ATTACH”. The format of the sender's phone number may be “+<country code> . . . ” or “0<area code> . . . ” Space characters are generally not allowed between two digits. An example of such an attach message to connect to the VPN is as follows:

Attach VPN+491711234567 or

Attach VPN 07705551212

The phone number parameter in the command string may be used for security purposes, where only recognized numbers will initiate a VPN connection. Up to about five phone numbers, for example, may be predefined in non-volatile memory space of the RNE 48, which have legitimate rights to order RNEs to perform certain actions, such as establishing the on request VPN connection 62. One skilled in the art will realize that more or fewer than five phone numbers could also be stored in the RNE and used to establish VPN connections or other RNE functions.

If the RNE 48 is unable to confirm the sender because, for example, the identification number sent in the SMS is not stored on the RNE 48, the RNE may then reply to the originator of the SMS with an appropriate SMS message, such as:

Connect_error # <error text> # <connAgentUID>

SMS messages 66 used to initiate the VPN connection may also contain extra parameters associated with different pre-stored VPN parameters on the RNE 48. One benefit of pre-storing VPN parameters is that it allows maintenance engineers to connect the VPN clients on RNEs with alternate VPN servers, such as maintenance servers, in order to remove the RNE from a production network environment and place it in a maintenance or test network environment for maintenance or system upgrades, for example. The pre-stored VPN parameters contain information specific to the VPN server to which the client will connect, such as external IP addresses of the servers and encryption information. A sample SMS command for connecting the VPN client to an alternate VPN server may be:

Attach VPN 07705551212; VPN server IP; VPN username; VPN password

One of ordinary skill in the art will realize that the wake-up event for on-request VPN networks using SMS messages may be sent from the administrative unit 44 to the RNE 48 as illustrated in the embodiment in FIG. 3. Moreover, the SMS message may originate from an RNE 48 and be sent to the administrative unit 44 indicating an initiation of the VPN segment 62 when the RNE 48 has an alarm, for example.

Security of the transmissions on the VPN is achieved by standard authentication and encryption methods as discussed above. In a typical scenario of a typical mobile network several hundred RNEs of different capabilities are managed from the element manager. These RNEs consist of different product lines which use control modules tailored to the necessary functionality for each of the particular RNE model in order to optimize the product cost. In one embodiment, which is further protected against data manipulation, the transmissions within the VPN are separate for each of the integrated RNE's, with each RNE having its own key and/or encoded with its own encryption technique to accommodate the different control modules of the RNEs, which may range from a low level 16 bit embedded controller up to a Microsoft Windows® based 32 bit high performance controller. This VPN server implementation allows for the handling of VPN clients with different strong encryption algorithms, including no encryption at all.

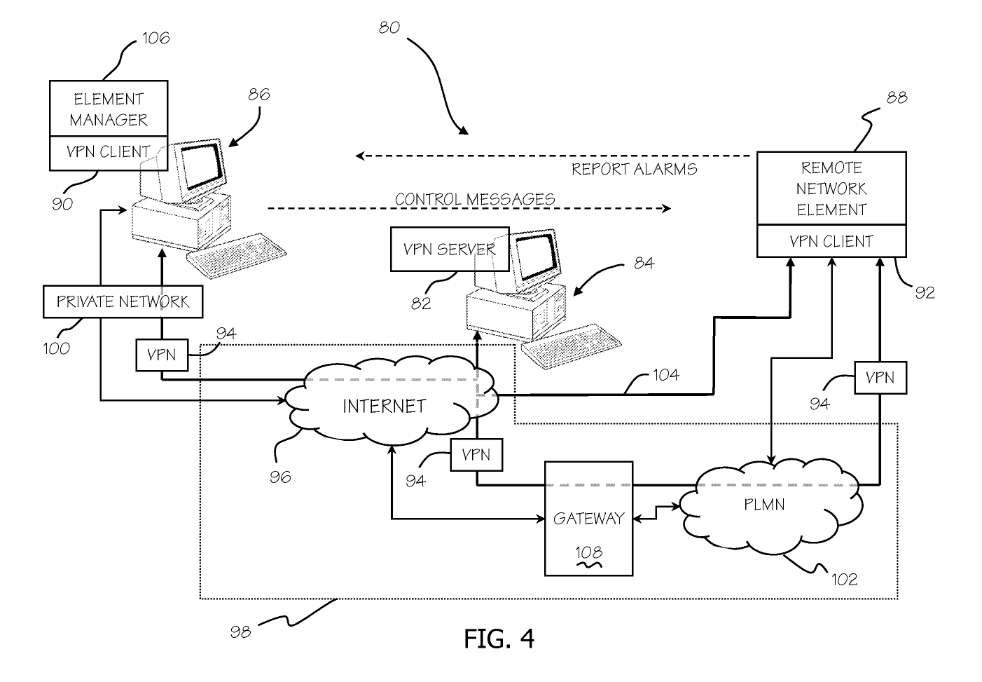

In an alternate configuration of the administration system 80, as seen in FIG. 4, the VPN server 82 may exist on a separate system 84. In this implementation, both the administration unit 86 and RNE 88 contain corresponding VPN clients 90 and 92 communicating through a VPN 94 and managed by the system 84 running the VPN server 82. System 84 may be connected directly to the Internet 96 having a public IP address in some embodiments, or in other embodiments, system 84 may be part of another sub-network (not shown) in the base network 98. Similarly, in some embodiments, the administration unit 86 may be part of another sub-network 100, which may also be private and may or may not be part of the base network 98. The VPN 94 may also tunnel through a gateway (not shown) protecting that sub-network. In another alternative embodiment, the VPN client 92 of RNE 88 might be linked to the VPN client 90 of the administration unit 86 independently of the PLMN 102 via VPN link 104.

The management application or element manager 106 operates on the VPN 94 on all above described variants of the invention. All data traffic, which is transferred by the management application (element manager 106) between the RNE 88 and the administration unit 86, occurs via the VPN 94. Gateway 108 is “tunneled” by the VPN 94, and thus does not interfere with the communication between the VPN server 82 on system 84, administration unit 86 and the RNE 88.

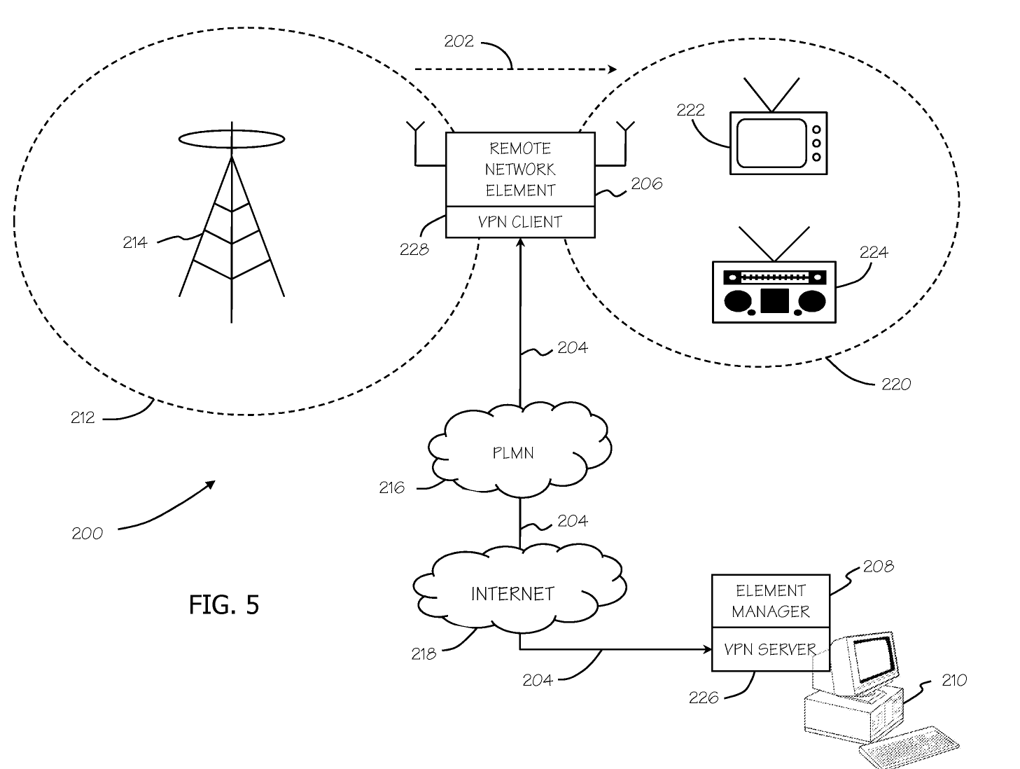

Turning now to FIG. 5, the VPN methodology for management of a remote device may also be applied in FM or television broadcast systems, such as system 200. These systems are generally transmit only systems, i.e. there is only a downlink signal 202. The data connection 204 for remote management between the RNE 206 and an element manager 208 executing, for example on administration unit 210, can be realized independent of the FM-radio or TV network, in which the RNE 206 is integrated. For example, the RNE 206 may be accessed separately from the broadcast network, which generally broadcasts to a coverage area 212 from a transmission tower 214, via a PLMN 216 and the Internet 218 for the purpose of remote control. RNE 206 may be used to expand the coverage area 220 through tunnels, in buildings, or in rural areas in order to be received by televisions 222 and/or radios 224, for example. For security purposes and similar to the embodiments set forth above, a VPN may be established between a VPN server 226 on the administration unit 210 and a VPN client executing 228 executing on the RNE 206. The VPN is used to tunnel through any gateways (not shown) encountered on private networks between the administration unit 210 and the RNE 206, as well as provide a secure data connection 204 through public networks, such as the Internet, similar to the embodiments set forth above.

Using a VPN to tunnel through a firewall of a blocking gateway and through a public network provides advantages over conventional implementations and systems. Benefits of using the VPN over other known methods require no extra effort for network administrators to adjust their gateways or other core network components. If neutral hosts are operating the RNE equipment, the hosts would not have the ability to reconfigure gateways or other secure network components because these components belong to the network operators, not the VPN. But supervision and remote control of RNEs are possible through a VPN. Additionally, service providers can offer RNE management solutions to network operators who own and utilize RNEs.

While all of the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the applicant's general inventive concept.

What is claimed is:

1. A system for remote control of a remote network element of a wireless network comprising:
an administration unit;
a virtual private network implemented on a base network connecting the administration unit and the remote network element; and
an element management application executing on the administration unit and operable to remotely control the remote network element through the virtual private network.

2. The system of claim 1, wherein virtual Ethernet tunneling is used in combination with the virtual private network implemented on the base network.

3. The system of claim 1, further comprising:
a VPN-Server operating the virtual private network.

4. The system of claim 3, wherein the VPN-Server is integrated in the administration unit.

5. The system of claim 1, wherein the base network comprises transport medium from a group consisting of a PLMN, a PSTN, the Internet, a DCN, or combinations thereof.

6. The system of claim 1, wherein the base network comprises:
a first network; and
a second network connected to the first network through a gateway.

7. The system of claim 6, wherein the remote network element is connected to the second network and wherein the second network is a private network.

8. The system of claim 7, wherein the remote network element communicates on the second network via a TCP/IP application.

9. The system of claim 8, wherein the TCP/IP application is selected from the group consisting of HTTP, SNMP, DHCP, DNS, FTP, Gopher, IMAP, IRC, NNTP, XMPP, MIME, POP, SIP, SMTP, SSH, TELNET, BGP, RPC, RTP, RTCP, TLS/SSL, SDP, SOAP, and combinations thereof.

10. The system of claim 1, wherein the virtual private network is protected by a cryptographic encryption.

11. The system of claim 1, wherein the remote network element is a first remote network element, the system further comprising:
a second remote network element connected to the administration unit through the virtual private network.

12. The system of claim 11, wherein a data exchange for the first and the second remote network elements is encrypted separately.

13. The system of claim 1, wherein the remote network element interfaces with the base network and is included in the virtual private network.

14. The system of claim 1, wherein the element management application is implemented on the administration unit.

15. The system of claim 1, wherein the virtual private network is maintained between the administration unit and the remote network element.

16. The system of claim 1, wherein the virtual private network connects the administration unit and the remote network element on-demand.

17. The system of claim 16, wherein the virtual private network connection is initiated with a message sent using SMS.

18. The system of claim 16, wherein the virtual private network connection is initiated in response to an alarm at the remote network element.

19. The system of claim 16, wherein the virtual private network connection is initiated in response to a periodic heart beat signal.

20. A method of remotely controlling a remote network element of a wireless network, the method comprising:
establishing a virtual private network implemented on a base network connecting an administration unit and the remote network element;
establishing transmissions between the administration unit and the remote network element through the virtual private network; and
remotely controlling the remote network element through the virtual private network with an element management application executing on the administration unit.

21. The method of claim 20, further comprising:
establishing a virtual Ethernet tunnel in combination with the virtual private network implemented on the base network.

22. The method of claim 20 further comprising:
operating the virtual private network via a VPN-Server.

23. The method of claim 20, wherein the base network includes a first network, and a second network, the method further comprising:
connecting the first network and the second network through a gateway.

24. The method of claim 23, further comprising:
connecting the remote network element to the second network,
wherein the second network is a private network.

25. The method of claim 24, wherein the remote network element communicates on the second network via a TCP/IP application.

26. The method of claim 25, wherein the TCP/IP application is selected from the group consisting of HTTP, SNMP, DHCP, DNS, FTP, Gopher, IMAP, IRC, NNTP, XMPP, MIME, POP, SIP, SMTP, SSH, TELNET, BGP, RPC, RTP, RTCP, TLS/SSL, SDP, SOAP, and combinations thereof.

27. The method of claim 20, further comprising:
utilizing cryptographic encryption to protect transmissions on the virtual private network.

28. The method of claim 20, wherein the remote network element is a first remote network element, the method further comprising:
establishing transmissions between the administration unit and a second remote network element through the virtual private network.

29. The method of claim 28, further comprising:
encrypting a first data exchange between the administration unit and the first remote network element; and
separately encrypting a second data exchange between the administration unit and the second remote network element.

30. The method of claim 20, further comprising:
implementing the element management application on the administration unit.

31. The method of claim 20, wherein the virtual private network is maintained between the administration unit and the remote network element.

32. The method of claim 20, wherein the virtual private network establishes a connection between the administration unit and the remote network element on-request.

33. The method of claim 32, further comprising:
initiating the virtual private network connection with a message sent using short message service (SMS).

34. The method of claim 32, wherein the virtual private network connection is initiated in response to an alarm at the remote network element.

35. The method of claim 32, wherein the virtual private network connection is initiated in response to a periodic heart beat signal.
